(19) United States
(12) Patent Application Publication
(10) Pub. No.: US 2015/0309763 A1
(43) Pub. Date: Oct. 29, 2015

(54) SYSTEM AND METHOD FOR IMAGE DISPLAY

(71) Applicant: Samsung Display Co., Ltd., Yongin-City (KR)

(72) Inventors: YONG SON, Suwon-si (KR); SUNGJIN CHOI, Hwaseong-si (KR); Dong-Ho KIM, Seoul (KR); Bongjun PARK, Suwon-si (KR); Yiseul SONG, Uiwang-si (KR); Jin-Ho OH, Seoul (KR); Jeehoon HAN, Asan-si (KR)

(21) Appl. No.: 14/618,567

(22) Filed: Feb. 10, 2015

(30) Foreign Application Priority Data
Apr. 29, 2014 (KR) 10-2014-0051721

(51) Int. Cl. G06F 3/14

(52) U.S. Cl. CPC G06F 3/1446

(57) ABSTRACT

An image display system includes a plurality of unit display devices, an image data buffer, and a location recognition unit. The location recognition unit recognizes the locations of the unit display devices and provides the image data buffer with location data. When the image data driver determines that the unit display devices are arranged in a first pattern, the plurality of unit display devices together displays a first image that corresponds to the first pattern.

### CROSS-REFERENCE TO RELATED APPLICATIONS

This U.S. non-provisional patent application claims priority under 35 U.S.C. §119 to Korean Patent Application No. 10-2014-0051721, filed on Apr. 29, 2014, the entire contents of which are hereby incorporated by reference.

### BACKGROUND

The present disclosure relates to a system and method for image display, and more particularly, to a system and method for displaying a puzzle-type image.

As the information age progresses, so does the demand for display devices that are capable of processing and displaying a lot of information. As a result, various display devices that are thin, light weight and consume less power have been introduced to replace existing display devices that use a cathode ray tube (CRT). For example, newer display devices may include a liquid crystal display device (LCD), a plasma display panel device (PDP), a field emission display device (FED), an organic electroluminescence device (OLED) and an electrophoretic display device (EPD).

### SUMMARY

The present system and method provide a puzzle-type image display system.

The present system and method also provide a method of displaying an image by a puzzle-type image display system.

Embodiments of the present system and method provide image display systems including: a plurality of unit display devices; an image data buffer; and a location recognition unit that recognizes the locations of the unit display devices and provides the image data buffer with location data, wherein when the image data driver determines that the unit display devices are arranged in a first pattern, the image display system displays a first image that corresponds to the first pattern.

In some embodiments, each of the unit display devices may have at least one of a circular shape, an elliptical shape and a polygonal shape.

In some embodiments, the location recognition unit may use at least one of WiFi, Zigbee, Bluetooth, chirp spread spectrum (CCS), near field communication (NFC) and 3D beacon technologies.

In still other embodiments, the location recognition unit may be installed in at least some of the unit display devices.

In even other embodiments, the location recognition unit may include a location measurement unit arranged in a location recognition space for recognizing the locations of the unit display devices.

In yet other embodiments, the location measurement unit may measure the locations of the unit display devices using at least one of infrared light, laser and an ultrasonic wave.

In further embodiments, the location recognition unit may be placed over the unit display devices.

In still further embodiments, each of the unit display devices may include: a buffer unit; and a unit display panel that is formed on the buffer unit and used to display the first image.

In even further embodiments, the buffer unit may have elasticity.

In yet further embodiments, the buffer unit may include at least one of rubber and plastic.

In much further embodiments, each of the unit display devices may further include a data transmission and reception unit that transmits and receives image data to and from neighboring unit display devices, wherein the data transmission and reception unit may be in contact with the buffer unit.

In still much further embodiments, the data transmission and reception unit may include a conductor.

In even much further embodiments, the each of the unit display devices may further include a connection unit that connects adjacent unit display devices.

In yet much further embodiments, the connection unit may surround at least a portion of the data transmission and reception unit.

In yet much further embodiments, the connection unit may include a magnet.

In yet much further embodiments, the image data driver may provide the unit display devices a first set of image data that corresponds to the first image.

In yet much further embodiments, when the unit display devices are arranged in a second pattern that is different from the first pattern, plurality of unit display devices may not display the first image.

In other embodiments of the present system and method, image display methods include recognizing the locations of a plurality of unit display devices; providing the unit display devices with a first set of image data that corresponds to a first pattern when the unit display devices are arranged in the first pattern; and displaying a first image that corresponds to the first set of image data on the unit display devices.

### BRIEF DESCRIPTION OF THE DRAWINGS

The accompanying drawings of the figures, which are included as part of the present disclosure, illustrate various embodiments, and together with their description herein, serve to explain and teach the principles of the present system and method. The figures, however, do not describe every aspect of the teachings disclosed herein and do not limit the scope of the claims. Furthermore, the figures are not necessarily drawn to scale and elements of similar structures or functions are generally represented by like reference numerals for illustrative purposes.

FIG. 1 is a block diagram of an image display system according to an embodiment of the present system and method;

FIG. 2 is a perspective view of an image display system according to an embodiment of the present system and method;

FIG. 3 is a perspective view of a unit display device according to an embodiment of the present system and method;

FIG. 4 is a plane view of when image data is displayed on an image display system according to an embodiment of the present system and method;

FIG. 5 is a plane view of when image data is not displayed on an image display system according to an embodiment of the present system and method;

FIG. 6 is a perspective view of an image display system according to an embodiment of the present system and method;

FIG. 7 is a perspective view of an image display system according to an embodiment of the present system and method; and

FIG. 8 is a flow chart of an image display method of an image display system according to an embodiment of the present system and method.

### DETAILED DESCRIPTION

The above objectives, other objectives, characteristics and advantages of the present system and method are described as exemplary embodiments with reference to the accompanying drawings. However, the present system and method are not limited to the disclosed embodiments but may be implemented in other forms. Rather, these embodiments are provided to help a person of ordinary skill in the art to understand the present system and method.

In describing each drawing, similar reference numerals are used for similar components. In the accompanying drawings, the dimensions of structures may be exaggerated for illustrative purposes. Although the terms ‘a first’ and ‘a second’ may be used to describe various components, these components should not be limited by these terms. Unless otherwise specified, the terms are used to distinguish a component from another component and not to convey an order of things or events. For example, unless otherwise specified, a first component and a second component may only differ in that they are not the same component. Terms that are used in singular form may include the plural form unless otherwise specified.

It should be understood that while the terms “includes” or “has” may indicate the presence of characteristics, numbers, steps, operations, components, parts or combinations thereof represented in the present disclosure, the terms do not exclude the presence or addition of one or more other characteristics, numbers, steps, operations, components, parts or combinations thereof. Also, when a component such as a layer, a film, an area, or a plate is referred to as being “on” another component, it can be directly on the other component or intervening components may also be present in between. Likewise, when a component such as a layer, a film, an area, or a plate is referred to as being “under” another component, it can be “directly under” the other component or intervening components may also be present in between.

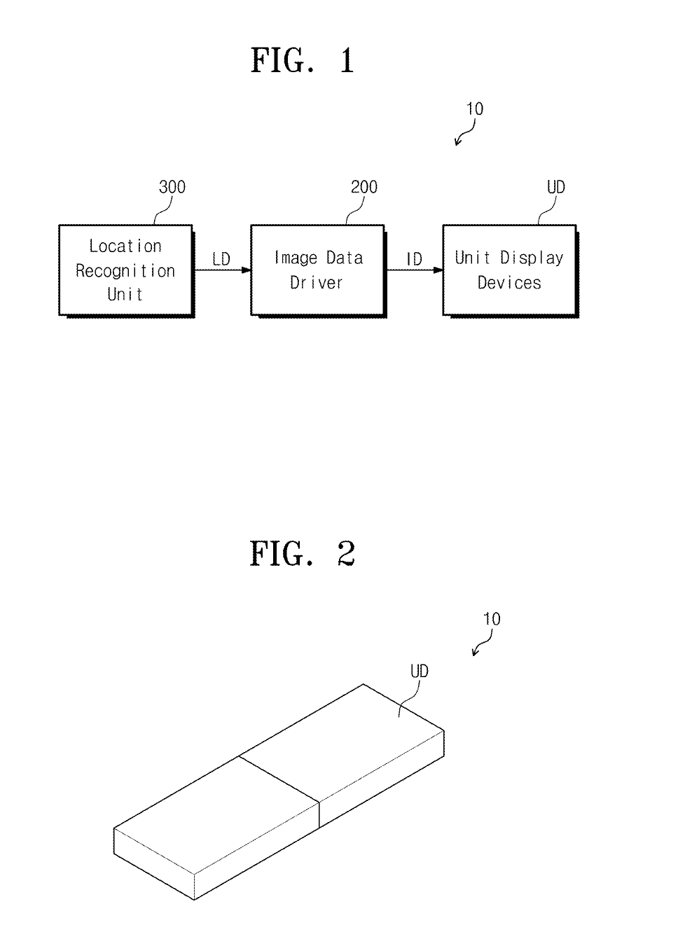

FIG. 1 is a block diagram of an image display system according to an embodiment of the present system and method. FIG. 2 is a perspective view of an image display system according to an embodiment of the present system and method.

Referring to FIGS. 1 and 2, an image display system 10 includes a plurality of unit display devices UDs, an image data driver 200 and a location recognition unit 300. The image data driver 200 may be included in at least some of the unit display devices UDs. However, the present system and method are not limited thereto and the image data driver may be external to the unit display devices UDs.

The location recognition unit 300 recognizes the locations of the unit display devices UDs and transmits location data LD to the image data driver 200. The image data driver 200 provides image data ID to the unit display devices UDs. For example, the image data driver 200 provides a first set of image data that corresponds to a first pattern to the unit display devices UDs when the unit display devices UDs form the first pattern. The unit display devices UDs receive the first set of image data that corresponds to the first pattern and display a first image that corresponds to the first set of image data.

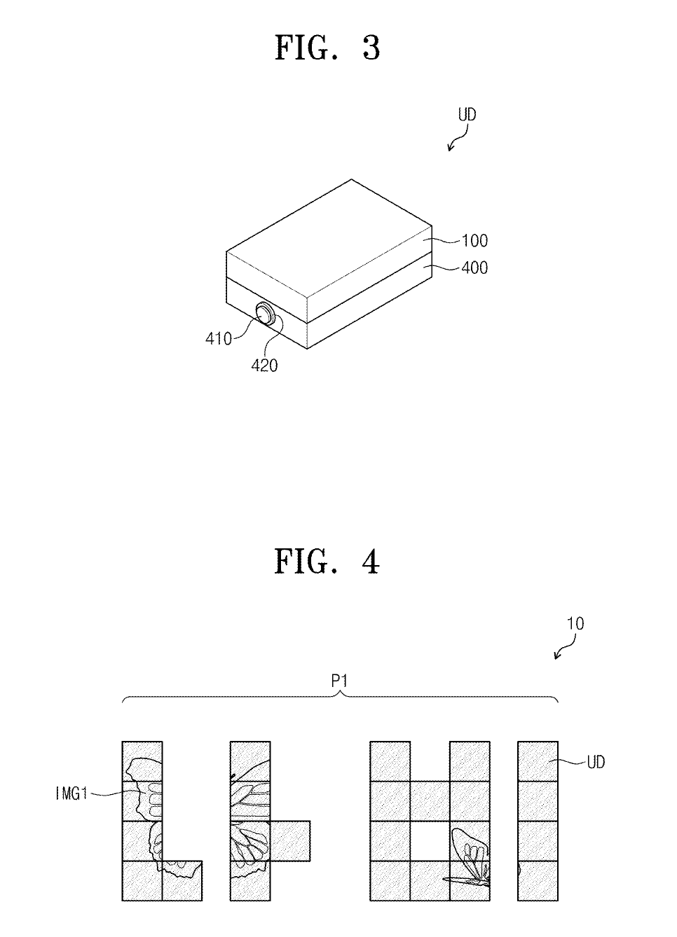

FIG. 3 is a perspective view of a unit display device according to an embodiment of the present system and method and shows that each of the unit display devices UDs may include a unit display panel 100 and a buffer unit 400. The unit display panel 100 may be one of various types of display panels such as an organic light emitting display panel, a liquid crystal display panel, a plasma display panel, an electrophoretic display panel, and an electrowetting display panel.

Although FIG. 3 shows the unit display devices UDs as having a quadrilateral shape, the present system and method are not limited thereto. For example, the unit display devices may have a circular shape, an elliptical shape and/or a polygonal shape.

The buffer unit 400 may be formed on the lower part (orientation as shown in FIG. 3) of each of the unit display devices UDs and have the same shape as the unit display device UD. However, the present system and method are not limited thereto. The buffer unit 400 may have a different shape from the unit display device UD.

The buffer unit 400 may have elasticity, which prevents or otherwise reduces damage to the unit display devices UDs if the unit display devices UDs fall. Further, a buffer unit 400 that is elastic may help to prevent a user from being injured by the edges of the unit display devices UDs during use. Examples of materials that are suitable for forming the buffer unit 400 include rubber and plastic such as thermosetting plastic or thermoplastic. In some cases, the plastic may be environmentally friendly plastic such as bio degradable plastic, which degrades into water and carbon dioxide by microorganism, and thus, does not emit an environment pollutant. Also, the plastic may be non-toxic plastic so that the image display system 10 may be used safely by children, such as for educational and entertainment purposes.

As mentioned previously, the image display system 10 may further include the image data driver 200, which provides the image data ID to the image display system 10. The image data driver 200 may be arranged on at least one of the unit display panels 100 or included in the buffer unit 400. In some cases, the image data driver 200 may be formed outside the unit display device UD and provide the image data ID wirelessly.

FIG. 3 illustrates that each of the unit display devices UDs may further include a data transmission and reception unit 410 for receiving the image data ID from the image data driver 200. For example, when the unit display devices UDs are arranged in a first pattern, the image data driver 200 provides a first set of image data to the data transmission and reception unit 410.

Although the image data driver 200 is exemplarily described as storing and providing a first set of image data, the image data driver 200 may include other image data. For example, the image data driver 200 may further include a second set of image data that corresponds to a second pattern that is different from the first pattern, a third set of image data that corresponds to a third pattern that is different from both the first pattern and the second pattern, and so forth.

The data transmission and reception unit 410 of a first unit display device UD may transfer the first set of image data to a second unit display device UD that is adjacent. The data transmission and reception unit 410 may also transfer a power source signal or a power signal.

Although FIG. 3 shows the data transmission and reception unit 410 as having a circular shape, the present system and method are not limited thereto. For example, the data transmission and reception unit 410 may have a circular shape, an elliptical shape and/or a polygonal shape.

The data transmission and reception unit 410 may be in contact with the buffer unit 400. For example, the data transmission and reception unit 410 may be arranged on the side of buffer unit 400. However, the present system and method are not limited thereto. For example, at least a portion of the data transmission and reception unit 410 may be formed in the unit display device UD or in the buffer unit 400. Also, the data transmission and reception unit 410 may be formed on the top or bottom of the buffer unit 400.

Each unit display devices UD may include a plurality of data transmission and reception units 410. For example, a plurality of data transmission and reception units may be arranged on one or more sides of the buffer unit 400. The data transmission and reception unit 410 may include any mechanism or structure through which image data can be transferred, such as an electrical conductor or a wireless transmission device.

FIG. 3 illustrates that each of the unit display devices UDs may further include a connection unit 420. The connection unit 420 may connect the adjacent unit display devices UDs with each other. Each unit display device may include a plurality of connection units 420, which may be arranged on one or more sides of the buffer unit 400. The connection unit 420 may surround at least a portion of the data transmission and reception unit 410, such as shown in FIG. 3. However, the present system and method are not limited thereto. For example, the connection unit 420 may be separated from the data transmission and reception unit 410. The connection unit 420 may include a magnet to connect neighboring unit display devices UDs together.

In some embodiments, the image display system 10 may further include an anti-disturbance unit (not shown) that prevents or otherwise reduces disturbances that may be caused by the connection unit 420 to the signals being communicated via the data transmission and reception unit 410. By further including the anti-disturbance unit (not shown), the data transmission and reception unit 410 may better transmit and receive data and other signals.

FIG. 4 is a plane view of when image data is displayed on an image display system according to an embodiment of the present system and method. That is, when the unit display devices UDs are arranged in a first pattern P1, the unit display devices UDs receive the first set of image data that corresponds to the first pattern P1 from the image data driver 200 and display a first image IMG1. The first set of image data may be stored in the image data driver 200.

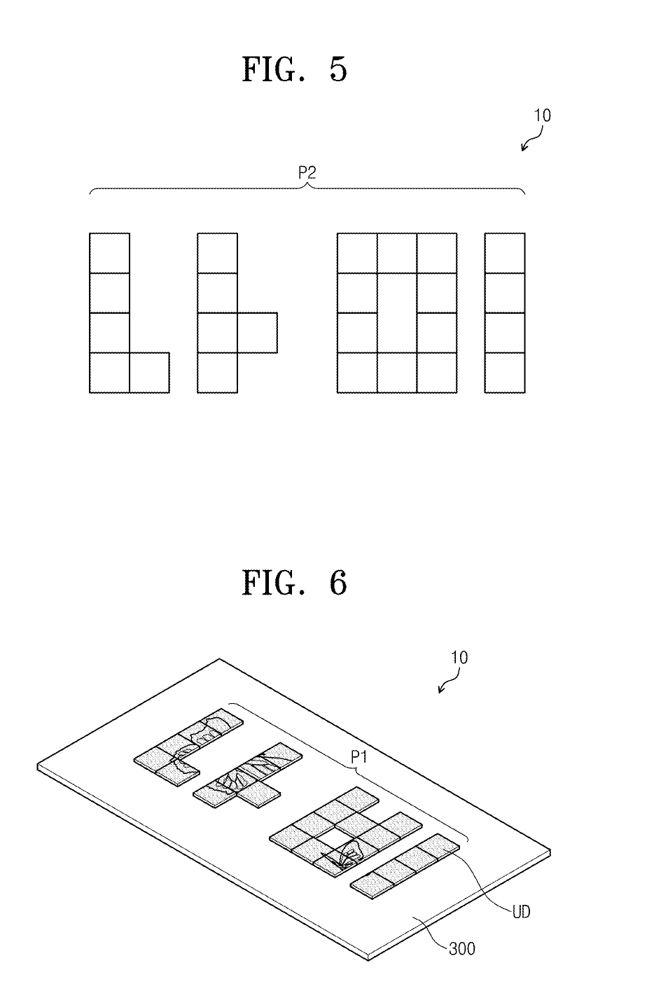

FIG. 5 is a plane view of when image data is not displayed on an image display system according to an embodiment of the present system and method. That is, when the unit display devices UDs are arranged to have a second pattern P2 that is different from the first pattern P1, the unit display devices UDs display do not display the first image IMG1.

Referring to FIGS. 4 and 5, the image data driver 200 of the image display system 10 uses Korean characters “ [symbol] ,” which means butterfly, as the first pattern P1 and stores corresponding image data for a butterfly image as the first set of image data. Referring to FIG. 4, when the unit display devices UDs are arranged in a pattern that corresponds to the “ [symbol] ,” the unit display devices UDs receive the first set of image data and together display a butterfly image. However, referring to FIG. 5, when the unit display devices UDs are arranged to correspond to Korean characters “ [symbol] ,” a pattern that is different from the first pattern P1, the unit display devices UDs may not receive the first set of image data and do not display the butterfly image.

Although FIGS. 4 and 5 describe an example of the image display system 10 that uses various Korean characters as the first pattern P1, the present system and method are not limited thereto. The first pattern P1 in which the unit display devices UD may be arranged to display an image may be any pattern. For example, when the unit display devices UDs are arranged in the shape of a butterfly, the unit display devices UDs may receive the first set of image data and display the butterfly image.

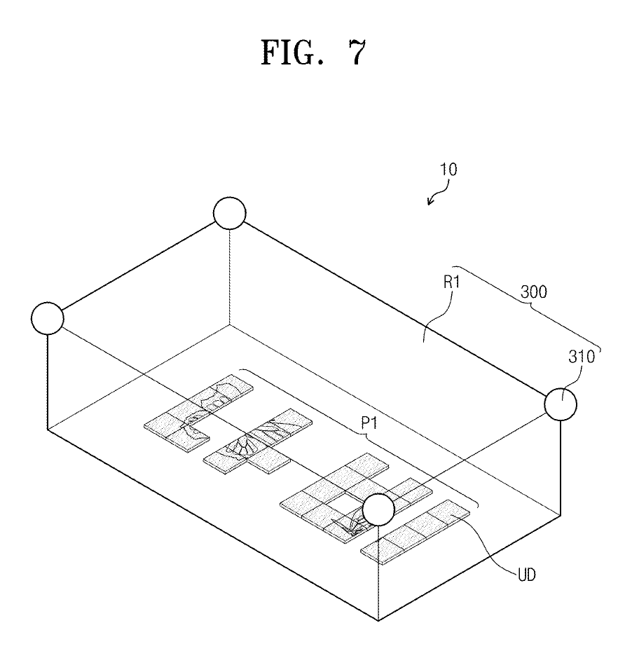

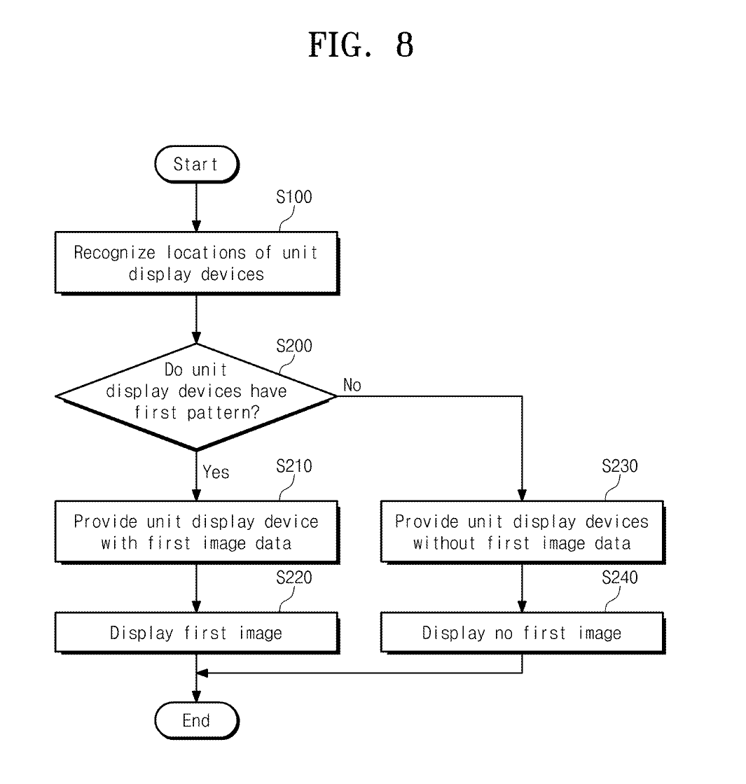

FIG. 6 is a perspective view of an image display system according to an embodiment of the present system and method. FIG. 7 is a perspective view of an image display system according to another embodiment of the present system and method.

Referring to FIGS. 1, 6 and 7, the image display system 10 may further include a location recognition unit 300 that recognizes the locations of the unit display devices UDs. The location recognition unit 300 may recognize the locations of the unit display devices UDs and determine the shape of a pattern in which the unit display devices UDs are arranged. The location recognition unit 300 provides the image data driver 200 with location data on the unit display devices UDs.

The location recognition unit 300 may use any short-range or long-range location recognition technology that those of ordinary skill in the art would find to be suitable, such as WiFi, Zigbee, Bluetooth, chirp spread spectrum (CCS), near field communication (NFC) and 3D beacon technologies.

Referring to FIG. 6, the location recognition unit 300 may be formed under the unit display devices UDs. The location recognition unit 300 may include one or more location sensors (not shown) that can recognize the location of each of the unit display devices UDs. In some cases, the location recognition unit 300 may also include one or more fixing structures (not shown) that allocate a plurality of fixed locations such that the unit display devices UDs can only be placed at the fixed locations. The fixing structures may be of a barrier type, for example. The fixing structures may prevent the unit display devices UDs from becoming displaced from their arranged positions due to an external shock.

Referring to FIG. 7, the location recognition unit 300 may include one or more location measurement units 310, which may be arranged in a location recognition space R1 to recognize or measure the locations of the unit display devices UDs. FIG. 7 illustrates that when the location recognition space R1 is of a rectangular parallelepiped, the location measurement unit 310 may be arranged at each of the four top corners of the rectangular parallelepiped to recognize or measure the locations of the unit display devices UDs. Having determined the locations of the unit display devices UDs, the location recognition unit 300 provides the image data driver 200 with location data so that the image data driver 200 can check whether the unit display devices UDs are arranged in a pattern that matches the first pattern P1.

The location measurement unit 310 may measure the locations of the unit display devices UDs by means that those of ordinary skill in the art would find to be suitable, such as using infrared lights, lasers and ultrasonic waves.

The image display system according to an embodiment of the present system and method may display a first image that corresponds to a first pattern when the unit display devices UDs are arranged in the first pattern to allow users to recognize a specific image associated with a specific pattern. For example, when the unit display devices UDs are arranged in a pattern that corresponds to a word, whether in Korean, English, or some other language, displaying an image that corresponds to the word may enable children to efficiently learn the word. In addition, when the unit display devices UDs are arranged in a specific shape, for example, a butterfly shape, displaying an image that corresponds to a butterfly may enhance understanding of the butterfly.

In the following, an exemplary image display method of an image display system is described. FIG. 8 is a flow chart of an image display method of an image display system according to an embodiment of the present system and method.

Referring to FIG. 8, the image display method includes recognizing the locations of a plurality of unit display devices UDs in step S100. For example, it is possible to recognize the locations of the unit display devices UDs using a location recognition unit. The location recognition unit may provide an image data driver with location data.

After the locations of the unit display devices UDs are recognized, the image data driver checks whether the unit display devices UDs are arranged in a first pattern in step S200. If the unit display devices UDs are arranged in the first pattern, the image data driver provides a first set of image data is provided to the unit display devices UDs in step S210. However, if the unit display devices UDs are arranged in a second pattern that is different from the first pattern, the first set of image data is not provided to the unit display devices UDs in step S230. For example, the image data driver may determine that the unit display devices UDs are arranged in a pattern different from the first pattern if the detected locations of the unit display devices UDs do not correspond to location coordinates associated with the first pattern and stored in the image data driver.

The unit display devices UDs receive the first set of image data and display a first image that corresponds to the first set of image data in step S220. For example, when the unit display devices UDs are arranged in the first pattern, the unit display devices UDs receive the first set of image data from the image data driver and display the first image corresponding to the first set of image data. However, when the locations of the unit display devices UDs are not stored in the image data driver and the unit display devices UDs are arranged in a second pattern that is different from the first pattern, the first set of image data is not provided to the unit display devices UDs and thus the first image that corresponds to the first set of image data is not displayed by the unit display devices UDs in step S240.

While embodiments of the present system and method are described with reference to the accompanying drawings, a person skilled in the art would understand that the described embodiments may be modified in various different ways, all without departing from the spirit or scope of the present system and method. Therefore, the above-described embodiments should be understood to be illustrative and not limitating.

What is claimed is:

1. An image display system comprising:
a plurality of unit display devices;
an image data driver; and
a location recognition unit that recognizes the locations of the unit display devices and provides the image data driver with location data,
wherein when the image data driver determines that the unit display devices are arranged in a first pattern, the plurality of unit display devices together displays a first image that corresponds to the first pattern.

2. The image display system of claim 1, wherein each of the unit display devices has at least one of a circular shape, an elliptical shape and a polygonal shape.

3. The image display system of claim 1, wherein the location recognition unit uses at least one of WiFi, Zigbee, Bluetooth, chirp spread spectrum (CCS), near field communication (NFC) and 3D beacon technologies.

4. The image display system of claim 1, wherein the location recognition unit is included in at least some of the unit display devices.

5. The image display system of claim 1, wherein the location recognition unit includes a location measurement unit arranged in a location recognition space for recognizing the locations of the unit display devices.

6. The image display system of claim 5, wherein the location measurement unit measures the locations of the unit display devices using at least one of infrared light, laser and an ultrasonic wave.

7. The image display system of claim 1, wherein the location recognition unit is placed over the unit display devices.

8. The image display system of claim 1, wherein each of the unit display devices comprises:
a buffer unit; and
a unit display panel that is formed on the buffer unit and used to display the first image.

9. The image display system of claim 8, wherein the buffer unit has elasticity.

10. The image display system of claim 8, wherein the buffer unit comprises at least one of rubber and plastic.

11. The image display system of claim 8, wherein each of the unit display devices further comprises a data transmission and reception unit that transmits and receives image data to and from neighboring unit display devices,
wherein the data transmission and reception unit is in contact with the buffer unit.

12. The image display system of claim 11, wherein the data transmission and reception unit comprises a conductor.

13. The image display system of claim 11, wherein each of the unit display devices further comprises a connection unit that connects adjacent unit display devices.

14. The image display system of claim 13, wherein the connection unit surrounds at least a portion of the data transmission and reception unit.

15. The image display system of claim 13, wherein the connection unit comprises a magnet.

16. The image display system of claim 1, wherein the image data driver provides the unit display devices a first set of image data that corresponds to the first image.

17. The image display system of claim 1, wherein when the unit display devices are arranged in a second pattern that is different from the first pattern, the plurality of unit display devices do not display the first image.

18. An image display method comprising:
recognizing locations of a plurality of unit display devices;
providing the unit display devices with a first set of image data that corresponds to a first pattern when the unit display devices are arranged in the first pattern; and
displaying a first image that corresponds to the first set of image data on the unit display devices.

19. An image display system comprising:
a plurality of unit display devices; and
a location recognition unit that recognizes the locations of the unit display devices and provides the unit display devices with location data,
wherein when the unit display devices are arranged in a first pattern, the plurality of unit display devices together displays a first image that corresponds to the first pattern.
